(19) United States
(12) Patent Application Publication
(10) Pub. No.: US 2007/0010990 A1
(43) Pub. Date: Jan. 11, 2007

(54) Method for sentence structure analysis based on mobile configuration concept and method for natural language search using of it

(76) Inventor: Soon-Jo Woo, Kyungki-do (KR)

Correspondence Address: MARGER JOHNSON & MCCOLLOM, P.C., 210 SW MORRISON STREET, SUITE 400, PORTLAND, OR, 97204, US

(21) Appl. No.: 10/553,856

(22) PCT Filed: Apr. 22, 2004
(86) PCT No.: PCT/KR04/00927

§ 371 Date: Oct. 19, 2005

(30) Foreign Application Priority Data
Apr. 24, 2003 (KR) 10-2003-0025995

(51) Int. Cl. G06F 17/28

(52) U.S. Cl. 704/4

(57) ABSTRACT

A method of syntax analysis based on a mobile configuration concept, and a natural language search method using the syntax analysis method, are provided. The syntax analysis method includes morpheme analysis and syntax analysis after establishing a morpheme dictionary program for analyzing morphemes of an input sentence, and a subcategorization database storing the details of subcategories belonging to heads, such as stems of words and word endings, of each component of a sentence such that the syntactic status of an inflective word ending is admitted based on the marker theory which regards both postpositions and endings as syntactic units, and combination relations between words can be grammatically defined as a whole. In the morpheme analysis, if a sentence desired to be analyzed is input, the contents of morphemes are analyzed in units of polymorphemes according to the morpheme dictionary program, and after selecting an analysis case of a morpheme appropriate to the input data among morpheme analysis data by polymorpheme, preprocessing is performed. In the syntax analysis, with the analyzed morphemes, partial structures of a sentence are first established according to grammatical roles stored in a grammar rule database, and then, by using the subcategorization database, the entire structure is established. Then, by calculating the weighted value of each structure, a most appropriate optimum case is determined and output. Accordingly, any scrambled sentence can be easily and quickly analyzed without any sophisticated parsing apparatus. Also, the grammatical relationships between expressions forming a sentence can be accurately captured such that information requested by a user is retrieved in the same manner as a human-being makes a decision, and accurate information can be provided.

### TECHNICAL FIELD

The present invention relates to a method of syntax analysis based on a mobile configuration concept and a method of natural language search using the analysis method, and more particularly, to a method of syntax analysis based on a mobile configuration concept in which grammatical role information defined in advance in subcategorization information is directly given to configuration constituents such that active response to free order language is enabled, and a method of natural language search using the analysis method.

### BACKGROUND ART

Syntax analysis means, in short, analysis of a syntactical structure of a natural language using a computer. Accordingly, for this syntactic analysis, transferring natural language knowledge to a computer for implementation is essential.

Development of a method for processing a natural language can be expressed briefly as teaching a language to a computer. For this conventional syntax analysis, a probability based method is used.

Here, the conventional probability-based syntax analysis is a method by which a large volume of a corpus is established and local structures and probabilities of transition in parts of speech are extracted from the corpus and then compared with actual data.

However, there are the following limits in this conventional probability-based syntax analysis. First, since there is no guarantee that a large volume of a corpus can cover all kinds of syntactical structures that can be made by human beings, in order to partially overcome this limitation, only a corpus limited to a predetermined area can be established. Accordingly, the completeness of knowledge cannot be guaranteed and the area of usage is limited.

Secondly, when incorrect analysis data is found, solving this problem is basically impossible. It is because the probability cannot be modified manually by a person. To solve this problem, a new corpus should be established and, when the size exceeds a predetermined level, there is a tendency for the probability to not change.

In particular, Korean grammar models to which these conventional probability-based syntax analysis methods are applied are broadly broken down into the traditional model based on Choi Hyon-Pai (1937) and the generative grammar model originating from Chomsky (1965).

However, these two models are not satisfactory because determination of syntactical units, which is an essential requirement of syntax analysis, is not consistent. That is, in the former method, a postposition is regarded as words, while an ending is regarded as morphological units. On the contrary, in the latter method, a postposition (or part of a postposition) is regarded as a morphological unit, while an ending is regarded as a word.

Accordingly, in the conventional methods, in order to analyze dependency relations between unit expressions forming given input data and to capture the grammatical function of them, a binary structure method based on the assumption that a grammatical function is determined by a configuration location is used.

In this binary structure, if a sentence, “Naneun Kongwoneso Youngheereul mannata (S) (I met Younghee in the park),” is analyzed, it is deemed that all units forming the sentence are paired to form the sentence. The sentence is divided into “Naneun (NP)” and “Kongwoneso Youngheereul mannata (VP)”, and VP is again divided into “Kongwoneso (PP)” and “Youngheereul mannata (V′)”, and V′ is again divided into “Youngheereul (NP)” and “mannata (V)”. In this structure, a dominance relation and a precedence relation are defined in one rule at the same time. That is, the subject is NP directly controlled by S, a location is PP directly controlled by VP, a direct object is NP directly controlled by V, and in this manner, grammatical functions are secondly defined.

In this conventional binary structure, grammatical functions of direct constituents of a sentence are determined by the locations of the constituents in the sentence structure. Even following the restriction on the order of words in Korean language that a predicate must be located at the end of a sentence, mathematically, if sentences each formed with 4 direct constituents are paired and structured, the number of mathematically possible cases is 7 (3×2×1+1), and in case of a sentence formed with 5 constituents, the number of equivalent structures is as many as 30 (4×3×2×1+2×2). Accordingly, the number of structurally equivalent cases increases geometrically.

Saying nothing of free-order languages such as Korean, even in the case of English, which is a fixed-order language, the preposition phrase is free for sentence inversion without changing the meaning of the sentence. This shows that grammatical functions cannot be determined by location in the sentence.

In addition, when the conventional binary structure is used for analysis, a sentence expressed by N unit expressions generates 2⁽ⁿ⁻²⁾ structurally equivalent cases. That is, as the number of polymorphemes forming a sentence increases, the number of cases of equivalent sentence structure increases geometrically.

Another problem of the binary structure is that there is no way to predict change in the locations of constituents. In the case of Korean, when the number of direct constituents of a sentence is n, the number of possible ways to change word locations is n!.

In particular, the capability to handle such free-order sentences is very important in processing spoken data, where there are frequent omissions and inversions, unlike written data. However, the conventional binary structure method cannot process this perfectly.

Accordingly, the conventional syntax analysis model for describing Indo-European language, which uses inflection, is not appropriate for Korean. The success ratio of the conventional syntax analysis method is only about 50˜60% due to its inherent limitations.

In particular, this conventional syntax analysis method follows a usage concept defining a grammatical function according to the used form of a component. According to this usage concept, in the following sentences:

1A. Youngheeneun haggyoe ganda. (Younghee goes to school.),

1B. Cheolsooneun haggyoe ganeun Youngheereul boatta. (Cheolsoo saw Younghee go to school.),

“ganda” in (1A) and “ganeun” in (1B) are both forms of the verb “gada (to go)”. However, “ganda” in (1A) completes a sentence, while “ganeun” in (1 B) does not complete a sentence, but modifies/restricts the following word “Younghee”. Accordingly, in conventional grammar, the usage form “ganeun” is referred to as a “pre-noun type”.

However, if a word is a verb and at the same time a pre-noun, from the conventional point of view, the problem of categorical indeterminancy is inevitable. That is, if “ganeun” in question is a pre-noun modifying “Younghee”, the pre-noun cannot lead the component “haggyoe”, and if “ganeun” is a verb, it cannot complete a sentence and whether or not it modifies the following noun cannot be explained.

Therefore, in order to solve this problem, the inner structure of “ganeun” should be analyzed and the structures of the stem “ga-” and the ending “-neun” should be referred to. However, the conventional syntactical rules do not take into account the inner structure of a word (a usage form). Thus, an engine that is independent of human linguistic knowledge cannot be realized.

Accordingly, due to these problems of the conventional syntax analysis, there are no commercialized Korean syntax analysis methods at present. Only laboratory level experiments have been carried out. Even in the case of machine translation, Korean syntax analysis technology is so lacking that only foreign language-to-Korean machines are available.

In addition, since existing natural language search engines operating based on conventional syntax analysis use only low level syntax analysis, or use indexation in units of polymorphemes, grammatical relations contained in each polymorpheme cannot be captured and retrieval is performed only according to a probability-based approach. Accordingly, a large volume of nonsensical information having a high usage frequency is detected and it is difficult to retrieve an essential result.

### BRIEF DESCRIPTION OF THE DRAWINGS

FIG. 1 is a flowchart of steps performed by a syntax analysis method based on a mobile configuration concept according to a preferred embodiment of the present invention;

FIG. 2 is a more detailed flowchart showing an example of a preprocessing step in FIG. 1;

FIG. 3 is a more detailed flowchart showing an example of a partial structure forming step of FIG. 1;

FIG. 4 is a diagram showing an example of a result screen when a syntax analysis method based on a mobile configuration concept of the present invention is used;

FIG. 5 is a flowchart of steps in a natural language retrieval method using a syntax analysis method based on a mobile configuration concept according to a preferred embodiment of the present invention;

FIG. 6 is a diagram showing examples of a question (retrieval words) input screen and a result screen in a natural language retrieval system using a syntax analysis method based on a mobile configuration concept of the present invention;

FIGS. 7 through 11 are diagrams showing step-by-step an example of an internal database for a natural language retrieval method using a syntax analysis method based on a mobile configuration concept of the present invention; and

FIG. 12 is a diagram showing an example of a print screen of a natural language retrieval method using a syntax analysis method based on a mobile configuration concept of the present invention.

### DETAILED DESCRIPTION OF THE INVENTION

Technical Goal of the Invention

The present invention provides a method of syntax analysis based on a mobile configuration concept by which core fundamental technologies required for development of a variety of useful tools capable of actively coping with the requirements of the accelerating information age can be provided, and which has robustness, universality, and high reliability because of being based on strict linguistic achievements such that it can be used in all areas, and by improving independence between linguistic knowledge and an analysis engine, performance can be continuously and rapidly improved such that it can be utilized very efficiently and economically, and a natural language retrieval method using the analysis method.

The present invention also provides a method of syntax analysis based on a mobile configuration concept by which any scrambled sentence can be easily analyzed without an additional analytical apparatus, and by handling an ending as a word and by controlling combinations of endings according to a phrase structure rule, independence between a linguistic model and an analysis engine can be improved with higher efficiencies in the model and engine, and a natural language retrieval method using the analysis method.

Also, the present invention provides a method of syntax analysis based on a mobile configuration concept by which grammatical relations between expressions forming a sentence can be accurately captured through indexation of component information using a mobile syntax analyzer, and as a result, information requested by a user is retrieved in the same manner as a human-being determines, such that accurate information can be provided, and a natural language retrieval method using the analysis method.

Disclosure of the Invention

According to an aspect of the present invention, there is provided a syntax analysis method for analyzing syntax and describing the grammatical function of the syntax, after establishing a morpheme dictionary program for analyzing morphemes of an input sentence, a grammar rule database for storing grammar rules, and a subcategorization database storing the details of subcategories belonging to heads, such as stems of words and word endings, of each component of a sentence such that the syntactic status of an inflective word ending is admitted based on the marker theory which regards both postpositions and endings as syntactic units, and the combination relations between words can be grammatically defined as a whole, the method including: analyzing morphemes wherein if a sentence desired to be analyzed is input, the contents of morphemes are analyzed in units of polymorphemes according to the morpheme dictionary program, and after selecting an analysis case of a morpheme appropriate to the input data among morpheme analysis data by polymorpheme, preprocessing is performed; and analyzing syntax wherein with the analyzed morphemes, partial structures of a sentence are first established according to grammatical roles stored in the grammar rule database, and then, by using the subcategorization database, the entire structure is established, and by calculating the weighted value of each structure, a most appropriate optimum case is determined and output.

In the method, analyzing syntax includes: performing preprocessing in which whether or not there is a sentence construction included in a multiple morpheme list is determined by a multiple morpheme list program, and if there is a multiple morpheme sentence construction, the multiple morpheme construction is transformed into a multiple morpheme form, and the meanings of words are determined by a semantic feature program and are included in morphemes; forming a partial structure by operating and repeating an internal loop, wherein if a morpheme tagged with the semantic feature part of speech is input, the morpheme is treated as an individual morpheme, and by determining according to grammatical roles stored in the grammar rule database whether or not local structure rules are applied to a morpheme selected, a local structure is formed and by referring to a succeeding object to be processed and by determining whether or not a recursive local structure is formed, an internal structure is established, and if there is no other internal structures, a following process is repeatedly performed; forming an entire structure according to the category and a sentence construction and an expression form based on the subcategorization database and the adjunct type database; selecting an optimum case by calculating the weight of each structure based on the location or the characteristic of a sentence construction and selecting a most important structure; and outputting an optimum case with mobile type (tree type) linking lines such that the relations among the entire structure, each partial structure, and each morpheme of the determined optimum case are correspondingly connected and indicated by the linking lines.

In the syntax analysis method, the semantic feature program is a program for classifying the meanings of words into predetermined types, the meanings being elements for determining the syntactic characteristic of a morpheme and meaning information, such that the meanings contribute to reducing structurally equivalency in a compound sentence structure and the list of adjuncts for each inflective word is determined; the multiple morpheme list program is a program performing classification by type in order to classify word features of postpositions in an identical type or suffixes having postposition functions; the grammar rule database stores information defining grammatical roles on respective primitives; the subcategorization database stores information on details of constituents that can belong to an inflective word, and forms of changeable inflective word endings; and the adjunct type database stores information on general features of postpositions, endings, or suffixes having functions similar to postpositions or endings, which determine the type of a local structure capable of being combined by a core word, as elements determining equivalency of a multiple branch structure.

According to another aspect of the present invention, there is provided a natural language retrieval method for retrieving documents (sentences) by inputting a natural language question using a syntax analysis method based on a mobile configuration concept, the method including: analyzing a document in which sentence analysis information of a document that is an object of retrieval is stored in a sentence information database by a syntax analysis method based on a mobile configuration concept wherein a subcategorization database, which stores the details of subcategories belonging to heads, such as stems of words and word endings, of each component of a sentence such that the syntactic status of an inflective word ending is admitted and the combination relations between words can be grammatically defined as a whole, is established, and if a sentence desired to be analyzed is input, the contents of morphemes are analyzed and with the analyzed morphemes, partial structures of a sentence are first established according to grammatical roles stored in a grammar rule database, and then, by using the subcategorization database, the entire structure is established; analyzing question syntax in which in the document information database, if a question in the form of a natural language is input, the syntax of the question is first analyzed according to the syntax analysis method based on the mobile configuration concept, the analyzed syntax analysis result is dissected in units of words according to syntax information, the interrogative sentence type of a question is captured, and dissected detailed question is determined; retrieving a document in which the role of the tag of the detailed question determined in a sentence analysis dictionary is converted into a tag for retrieval according to the desired interrogative sentence type, a word having the converted tag for retrieval is retrieved in the sentence analysis dictionary, and a ranking is calculated based on the frequency of retrieval; and displaying the result including retrieved words, sentences including tags for retrieval, and the contents of a document including the sentences.

Effect of the Invention

According to the syntax analysis method based on the mobile configuration concept of the present invention, and the natural language retrieval method using the syntax analysis method, as described above, core basic technologies required for developing a variety of useful interface tools can be provided and robustness and universal usage are provided so that the methods can be used in all areas of a computer system. In addition, because of continuous and rapid performance improvements, the present invention is economical. Accordingly, even scrambled sentences can be quickly and easily analyzed without a sophisticated parsing apparatus. Also, the grammatical relationships between expressions forming a sentence can be accurately captured such that information requested by a user is retrieved in the same manner as a human-being makes a decision, and accurate information can be provided.

### BEST MODE FOR CARRYING OUT THE INVENTION

Hereinafter, a method of syntax analysis based on a mobile configuration concept and a natural language search method using the analysis method according to the present invention will be described in detail by explaining preferred embodiments of the invention with reference to the attached drawings.

First, the method of syntax analysis based on a mobile configuration concept of the present invention is a syntax analysis method based on a subcategorization database storing the details of subcategories belonging to heads, such as stems of words and word endings, of each component of a sentence such that the syntactic status of an inflective word ending is admitted based on the marker theory and combination relations between words can be grammatically defined as a whole.

That is, this syntax analysis method can be said to be a knowledge-based approach because it can be applied to all languages by directly inputting the unique Korean grammar model and linguistic knowledge into a computer. An example of the subcategorization database will be explained with respect to each step of the method.

In the core grammar model of this marker theory, both a postposition and an ending are treated as syntactical units, that is, words. For example, in the usage concept described above, if there are sentences, “Youngheeneun haggyoe ganda (Younghee goes to school),” and “Cheolsooneun haggyoe ganeun Youngheereul boatta (Cheolsoo saw Younghee go to school),” the marker theory regards “-neun” of “ganeun” and “-n-” and “-da” of “ganda” as markers, and classifies the sentences into syntactical units as follows:

2A. [Younghee-neun haggyo-e ga]-n-da.

2B. [Cheolsoo-neun [haggyo-e ga]-neun Younghee-reul bo]-at-ta.

Also, the function of each marker is different.

That is, “-neun-” of “ganeun” plays a role of combining a verb phrase with a noun, while “-n-” of “ganda” indicates present (progressive) form, and “-da” indicates a predicate mode. Thus, the combination relation between words can be defined as a whole in the grammar, and accordingly, independence between grammar and an analysis engine improves and identifying incorrect analysis data or modification becomes easier.

Also, by employing a mobile configuration using an ID-LP format distinguishing the dominance relation and precedence relation, sentences formed with identical constituents but with scrambled orders can be analyzed identically.

A method of syntax analysis based on a mobile configuration concept according to a preferred embodiment of the present invention based on this marker theory is a syntax analysis method which describes the grammatical function of a sentence through syntax analysis.

In the method, in order to enable analysis of scrambled sentences, postpositions and endings are determined as independent words and the grammatical functions and features of morphemes are stored in a database in advance, and if a sentence requiring analysis is input, by using strict subcategorization details of a head of each component, syntax analysis is performed based on semantic features, postposition forms, and categorical identities included in the details. By doing so, excessive generation is curbed and based on grammatical role information defined in advance in subcategorization information, the relations between respective morphemes are specified by predetermined symbols and the grammatical relations of the sentence are described. Broadly, the method includes morpheme analysis (steps S1 through S3) and syntax analysis (steps S4 through S10).

In the morpheme analysis of the present invention, first, a morpheme dictionary program 1 in which postpositions and inflective word endings are determined as independent primitives and the characteristics of grammatical functions of endings are stored in the form of a morpheme dictionary, and a grammar rule database 4 in which grammar rules are stored, are established.

If a sentence desired to be analyzed is input in step S1, a morpheme, which is the smallest unit of a sentence structure, is analyzed by the morpheme dictionary program 4 in step S2, and the part of speech is tagged in a part of speech attaching step S3.

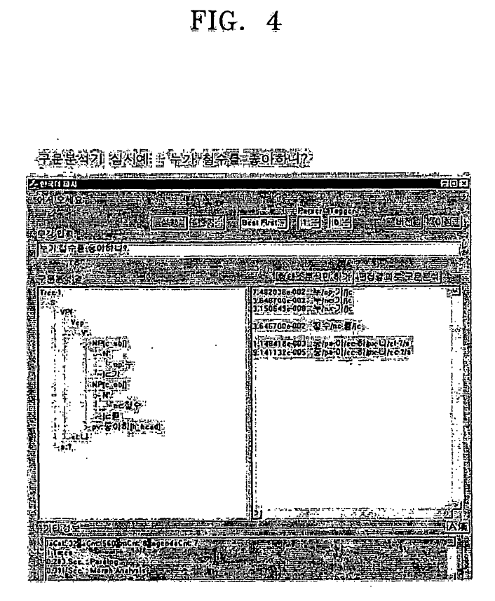

Here, tags and abbreviations indicating grammatical functions are attached to the classified morphemes. As shown in the right hand side window of the syntax analysis result windows of FIG. 4, constituents are classified into morphemes, each of which is a smallest unit having a meaning, such as subjects and subject postpositions, objects and object postpositions, and predicates and predicate endings, and tags are attached to respective morphemes and kinds of morphemes are indicated by marking abbreviations (np, jc, pv, etc.) in the tags.

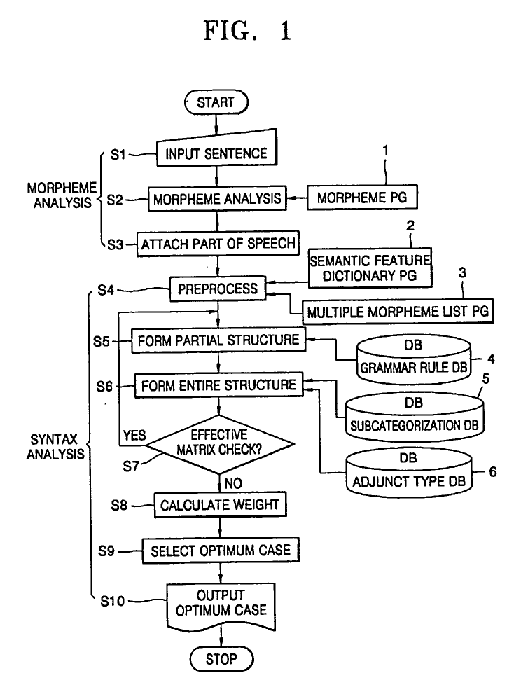

Then, in the syntax analysis steps S4 through S10 of the present invention, partial structures of a sentence are first formed according to the grammar rules of the classified morphemes, and the entire structure is established according to the expression forms. Then, by calculating the weight of each structure, an optimum case is determined and the relations between each morpheme are specified by predetermined symbols and the grammatical relations of the sentence are described. As shown in FIG. 1, the syntax analysis includes a preprocessing step S4, a partial structure forming step S5, entire structure forming steps S6 and S7, and entire structure finalizing steps S7 through S10.

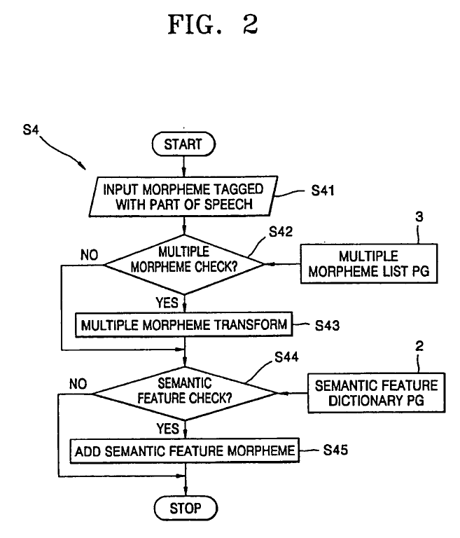

Here, in the preprocessing step S4, as shown in FIG. 2, if a morpheme tagged with a part of speech is input in step S41, whether or not there is a sentence construction of a multiple morpheme type is determined by the multiple morpheme list program 3 in step S42. If there is a multiple morpheme sentence construction, it is converted into the form of a multiple morpheme in step S43. The meaning of the morpheme is determined by a semantic feature dictionary program 2, and if a morpheme on a semantic feature is required in step S44, a semantic feature morpheme is added in step S45.

At this time, the semantic feature program 2, as exemplified below, is an element determining meaning information of a core word of a sentence part, and contributes to reducing structural equivalency in a compound sentence structure, and performs, by type, classification of meanings of words such as a general noun, such that the adjunct list for each inflective word can be determined.

<Examples of a Semantic Feature Dictionary Program>

| | |
|---|---|
| @root | bab (boiled rice) |
| @pos | nc |
| @type | concrete |
| @subtype | food |
| @property | solid |
| ...... | |
| @root | haggyo (school) |
| @pos | nc |
| @type | concrete\|abstract |
| @subtype | organization |
| ...... | |

Also, the multiple morpheme list program 3, as shown below, performs by type classification in order to classify word features of postpositions with an identical form or suffixes having the functions of postpositions.

<Examples of Multiple Morpheme List Program Application>

jc <− e/jc dae/nx − ha/xsv − eoseo/ec
......
jc <− wa/jc gad/pa − i/xsa
......
pv <− */nc−*/xsv
pv <− */nx−*/xsv
nc <− */nc−*/nx
......
ep <− ??/etm − geod/nb − i/co

{ep:tense=[fut]; ep:origin = [cep];}

......

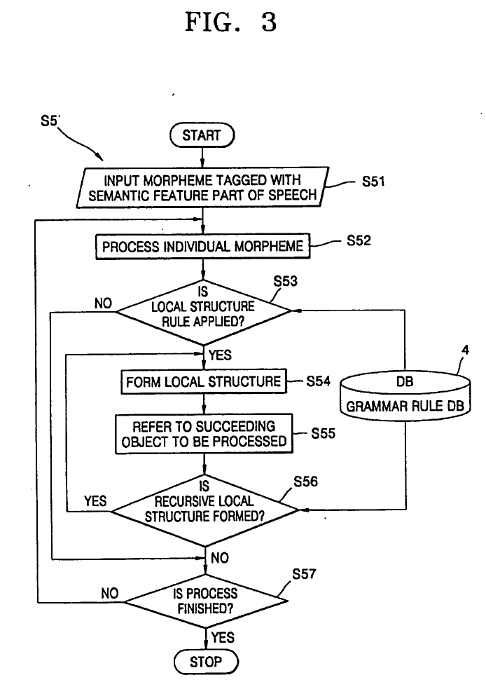

Next, in the partial structure forming step S5 shown in FIG. 3, if the semantic feature part of speech tagged morpheme is input in step S51, individual morphemes are processed in step S52, whether or not there is a local structure is determined according to the grammatical roles stored in the grammar rule database 4 in step S53, a local structure is formed in step S54, a following object to be processed is referred to in step S55, and a recursive local structure is formed in step S56. This recursive local structure includes internal loop operation steps S53 through S56 in which, by establishing again a partial local structure, a local structure is established, and an internal loop recursion step S5 in which if there is no other local structure, a next morpheme is selected and the steps are repeated.

Here, the grammar rule database 4 stores information defining grammatical roles for each primitive as shown in the following example.

<Example of a Rule Dictionary>

| | |
|---|---|
| N′ <− NPm N′ | <5> |

[NPm:nbval;]
{N′:type = N′#1:type;
N′:subtype = N′#1:subtype;
N′:property = N′#1:property;}

......
ADVP <− mag ADVP-s <4>

[s:lex == [,]; mag:subtype ** [degree];]
{ADVP:subtype = ADVP#1:subtype;}

......

Next, as shown in FIG. 1, the entire structure forming steps S6 and S7 include forming an entire structure according to the category of a sentence and expression forms based on the subcategorization database 5 and adjunct type database 6 in step S6, determining whether or not another form of an effective matrix is checked in step S7, and then repeating the partial structure forming step S5 of the following matrix.

Here, the subcategorization database 5 stores the details of subcategories belonging to heads, such as stems of words and word endings, of each component of a sentence such that the syntactic status of an inflective word ending is admitted based on the marker theory which regards both postpositions and endings as syntactic units, and the combination relations between words can be grammatically defined as a whole. As shown in the following example, in a head, “meogda (to eat)”, information on the forms of possible inflective word endings of “meog-” is stored.

<Examples of Subcategorization Database Application>

| | |
|---|---|
| meog | NP(subtype ˜= [human\|animal]; jcval *= < i >)[c_sbj] |

NP(type ˜= [concrete]; subtype ˜=
[food|medicine|abstract|fuel];

jcval *= < eul >)[c_obj]

{A_Type1}
pv

......

| | |
|---|---|
| meogi | NP(jcval *= < i >; !!(nbval); type ˜= [alive])[c_sbj] |

NP(jcval *= < ege >; type ˜= [alive])[c_dat]
NP(jcval *= < [symbol] >; subtype ˜= [food|liquid])[c_obj]
{A_Type1}
pv
......

In addition, the adjunct type database 6 stores information on general features of postpositions, or suffixes having functions of postpositions as elements determining equivalency of a multiple branch structure, as shown in the following examples.

<Examples of Adjunct Type Database Application>

#BOAT
A_Type1

ADVP(subtype ** [manner])[a_manner]
ADVP(subtype ** [time])[a_temp]
ADVP(subtype ** [motive])[a_reason]
...
NP(subtype ** [time]; !!(jcval) && nbval)[a_occurrence]
NP(subtype ˜=[place|space|spot]; jcval**< eseo >)[a_loc]
NP(type ** [concrete]; jcval**< ro >)[a_instr]
...
VPn(etnval == [ gi ]; jcval == [ e ])[a_motive]
VPf(mood ˜= [declarative]; jcval == [ go ])[a_reason]

A_Type2

......

A_Type3

......

......
#BOAT

Next, as shown in FIG. 1, the entire structure finalizing steps S7 through S10 include calculating importance weights of respective structures based on the location or the characteristic of a sentence construction in step S7, selecting an optimum case in step S8, and outputting the selected optimum case.

In this optimum case outputting step S10, as shown in the left-hand side window of the syntax analysis result windows of FIG. 4, mobile type (tree type) connections lines are marked such that corresponding relations among the finalized entire structure, respective internal structures and external structures, and respective morphemes are indicated by the lines.

Accordingly, by relying on the grammar model developed to suit Korean and linguistic knowledge, much higher accuracy than that of the conventional probability based method can be guaranteed. And, for a simple sentence, a processing rate near 100% can be expected, in principle, depending on the degree of knowledge establishment because the recognition method is the same as that of a human-being.

In addition, by employing a mobile configuration, even a scrambled sentence can be analyzed accurately and consistently, the method can be applied to all language areas, additional expenses due to domain change are not incurred, and unnecessary analysis decreases because of employing the multiple branch structure. Accordingly, identifying the reason for errors becomes easier and independence between knowledge and an engine is high such that correction of incorrect analysis data can be performed quickly.

Also, unlike the equivalency increasing by geometric progression in the conventional binary structure, structural equivalency increases by arithmetic progression with respect to increase in the number of polymorphemes, because of the multiple branch structure analysis having grammatical functions as primitives such that syntax analysis becomes easier and spoken data in which omissions and inversions occur frequently can be perfectly analyzed.

Meanwhile, a syntax analyzer implementing a syntax analysis method based on this mobile configuration concept includes a control unit such as a microprocessor or a CPU that controls a variety of input and output apparatuses, and a storage apparatus that stores various types of information such as a RAM, a ROM, or a hard disc.

The control unit includes the morpheme dictionary program 1, the semantic feature dictionary program 2, and the multiple morpheme list program 3 of FIG. 1. The storage apparatus includes the grammar rule database 4 that stores grammatical roles, the subcategorization database 5, and the adjunct type database 6.

That is, the control unit is programmed such that, if a sentence to be analyzed is input, it analyzes each morpheme of the sentence according to the morpheme dictionary program 1, and first establishes the partial structure of a sentence according to the grammatical roles stored in the grammar rule database 4, then establishes the entire structure based on the subcategorization information stored in the subcategorization database 5. And then, the control unit calculates the weight of each structure, selects an optimum case, specifies the relations between respective morphemes by predetermined symbols, and describes the grammatical relations of the sentence.

Accordingly, the syntax analyzer of the present invention does not use the method by which a grammatical role is inferred from configuration, but use a method by which a grammatical function itself is regarded as a primitive, and by using subcategorization information, a grammatical function is specified.

In addition, because just providing the list of parts of speech is not enough for this categorization information, the syntax analyzer of the present invention describes meaning information of each component such that equivalency is removed and only the simplest grammatical structures are generated.

For this, a system is designed such that in the morpheme analysis steps S1 through S3, semantic features of respective words can be shown, and as a result, possible grammatical relations can be accurately identified.

Also, each of the subcategorization frames requests allowable adjunct types for the frame. Accordingly, by describing the types according to the adjunct forms in the entire structure forming step S6, generation of an unnecessary equivalent structure can be prevented and appropriate syntax analysis can be performed.

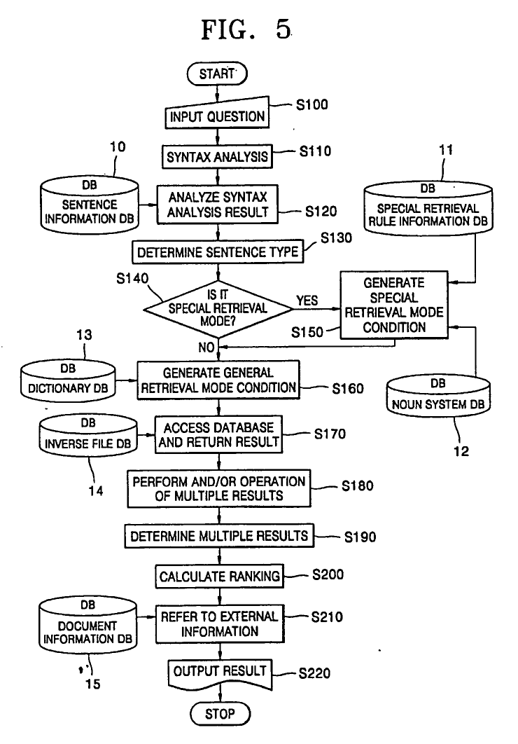

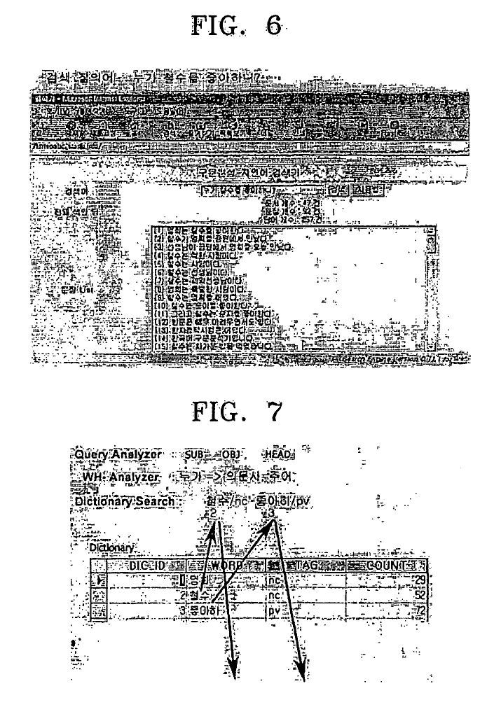

Meanwhile, a natural language retrieval method using the syntax analysis method based on a mobile configuration concept of the present invention is a retrieval method by which if a question in the form of a natural language is input, documents or sentences are searched and desired knowledge is found and returned. As shown in FIG. 5, and more broadly in FIG. 1, the method includes document analysis steps S1 through S10 using the syntax analysis method, document search steps S130 through S180, and result displaying steps S190 through S220.

That is, the document analysis, as shown in FIG. 1, not with a sentence input, but with a document input, is a syntax analysis method based on a mobile configuration concept in which the grammatical functions and features of morphemes are stored in advance in a database. And, if a sentence requiring analysis is input, by using primitives, morphemes are defined, and according to grammatical dominance relations of the database matching a morpheme defined as an ending in the defined morphemes, the relations between respective morphemes are specified by predetermined symbols such that the grammatical relations of the sentence are described. In the document analysis steps, sentence analysis information of the document that is the object of analysis is stored in an index database in the form of a sentence analysis dictionary, and this is the same as in the syntax analysis method described above.

After finishing this preparatory step, in the question syntax analysis steps S110 and S120, if a question in the form of a natural language asking desired information is input in step S100, by the syntax analysis method based on the mobile configuration concept described above, the sentence construction of the query sentence is analyzed in step S110. The result of the sentence construction analysis is dissected word-by-word according to sentence construction information, and by capturing an interrogative form of a question, a question is determined based on detailed questions of the sentence information database 10 that stores sentence information input in advance, in step S120.

Here, the query sentence in the form of a natural language is a language of a human-being that can be easily understood by a person on the basis of the way of thinking of a person. As shown in a “retrieval word” window at the top of FIG. 6, an example of such a sentence is “Nooga Cheolsooreul joahani? (Who likes Cheolsoo?)”

Accordingly, after this question syntax analysis step, the sentence construction of the question analysis result (Query Analyzer), “Nooga Cheolsooreul joahani?”, as shown in FIG. 6, can be defined as “SUB (subject) OBJ (object) HEAD (predicate)”.

For reference, an “entire index amount” window at the center of FIG. 6 shows the number of documents analyzed in advance in the document analysis step as “47”, the number of sentences as “92”, and the number of words as “257”.

Next, in the sentence type determination step 130 in the document retrieval step, the role of the tag of the detailed question determined in the dictionary with the dictionary database 13 as an object, is changed to the role for retrieval according to the form of a desired interrogative sentence, and a word having the changed tag for retrieval is retrieved in the dictionary database 13 in step S130.

That is, as shown in FIG. 6, the form of an interrogative sentence is analyzed and “Nooga=>interrogative word, subject” is derived. According to this, “Cheosooreul”, in which the role of the retrieval tag was to indicate an object, is converted into an object or a subject without change and the tag is converted into “Cheolsoo/nc”, and “Joahani?” which was an interrogative predicate is converted into a general predicate “Joaha/pv”, and these are searched for in the sentence analysis dictionary (Dictionary).

Here, the document retrieval step 130 may include a special retrieval mode condition generation step S150 of generating conditions for special retrieval mode by special retrieval rule information 11 and a noun system database 12 according to selection by a user. Alternatively, the document retrieval step 130 may include a general retrieval mode condition generation step S160 for performing general retrieval of the dictionary database 13.

The general retrieval mode is a retrieval method in which by using only syntactically analyzed information and based on only the result of syntax analysis of a question, a document database already analyzed is searched and matching contents are extracted and provided.

This general retrieval mode may use a component matching retrieval method by which data matching direct constituents of a given question are extracted and provided. Alternatively, the general retrieval mode may use a meaning matching retrieval method by which constituents forming a question are included but data containing predicates semantically similar to a predicate that is a core word are extracted and provided.

Meanwhile, the special retrieval mode is a method by which when a special expression is included in a question, based on the expression, contents semantically dependent on given constituents are retrieved and provided. For example, if a question, “Cheolsooga mooseun kwaileul meogeonni? (What fruit did Cheolsoo eat?)”, is input, documents having contents of Cheolsoo eating a predetermined type of fruit including “Cheolsooga sagwareul meogeodda (Cheolsoo ate an apple),” are extracted and provided as desired sentences.

That is, for this special retrieval mode, databases on semantic hierarchical structures of nouns such as the special retrieval rule information 11 and the noun system database 12 are used.

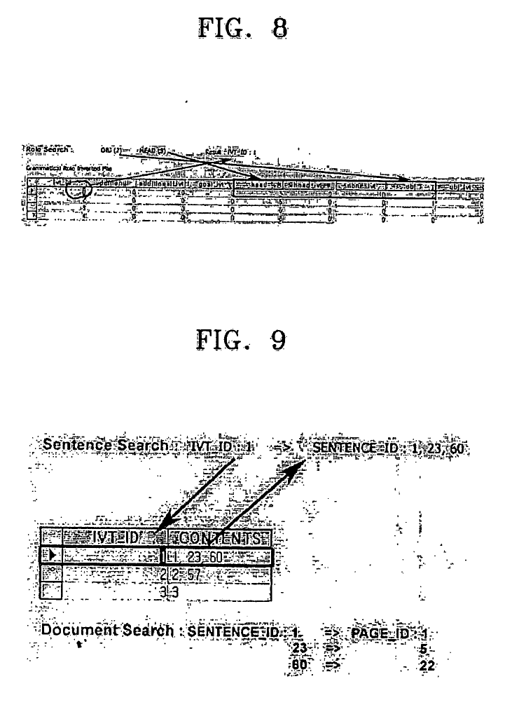

Next, as shown in FIG. 8, in order to generate data of an inverse file database 14 in which roles are reversed, the database is accessed and the result is returned in step S170, and the retrieval frequency of a word having a retrieval tag that is converted into an AND or OR condition of multiple results is calculated as shown in FIG. 9 in step S180.

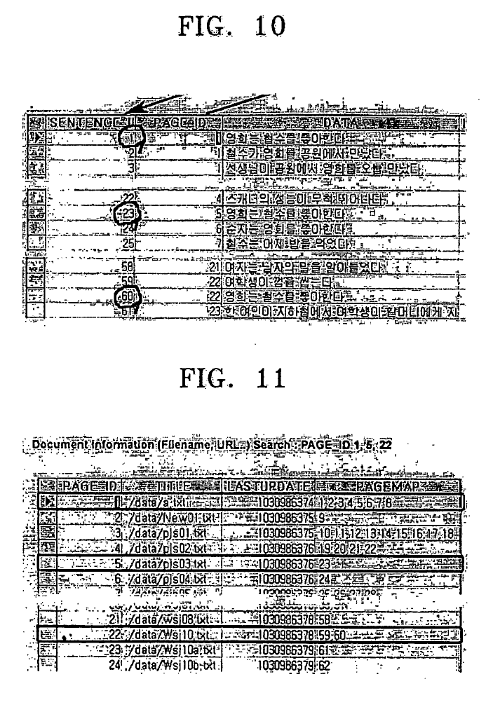

That is, as shown in FIGS. 9 and 10, the first sentence, “Youngheeneun Cheolsooreul joahanda. (Younghee likes Cheolsoo.)” of the first document, the 23rd sentence, “Youngheeneun Cheolsooreul joahanda,” and the 60th sentence, Youngheeneun Cheolsooreul joahanda,” are retrieved.

Next, in the result display steps S190 through S220, as shown in FIG. 11, a plurality of results such as retrieved words, sentences containing retrieval tags, information and contents of documents containing the sentences, are determined in step S190. The ranking is calculated according to frequency in step S200. The document information database 15 containing these is read out and external information is referred to in step S210. Finally, the result is output in step S220.

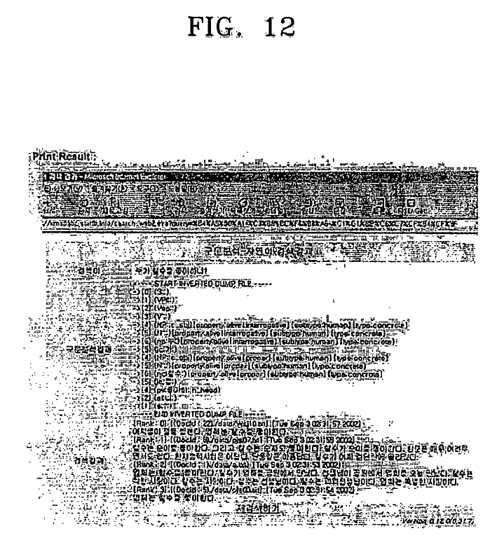

Accordingly, as shown in FIG. 12, if a question in a natural language, such as “Nooga Cheolsooreul joahani? (Who likes Cheolsoo?)”, is input in the retrieval word window, in the question syntax analysis window postpositions and endings are analyzed as morphemes and displayed as “Noo/np”, “ga/jc”, “Cheolsoo/nc”, “reul/jc”, “joaha/pv”, “ni/et”, and “?/s”.

These are retrieved with words having retrieval tags and the result is displayed in the retrieval result window. In the retrieval result window, a sentence such as “Cheolsooneun Soonjado joahanda. (Cheolsoo also likes Soonja)” may be displayed together with the sentence “Younghee likes Cheolsoo.”, so that the questioner can make a comprehensive determination.

Meanwhile, though not shown, a natural language retrieval system using this natural language retrieval method includes a control unit for controlling a variety of input and output apparatuses, such as a microprocessor or a CPU, and a storage apparatus that stores various types of information, such as a RAM, a ROM, or a hard disc. In the storage apparatus, an index database is established in the form of a sentence analysis dictionary (Dictionary) that stores sentence analysis information of a document that is an object of retrieval by a syntax analysis method based on a mobile configuration concept. In the syntax analysis method, the grammatical functions and features of morphemes are stored in advance in a database, and if a sentence requiring analysis is input, by using primitives, morphemes are defined, and according to grammatical dominance relations of the database matching a morpheme defined as an ending in the defined morphemes, the relations between respective morphemes are specified by predetermined symbols such that the grammatical relations of the sentence are described.

Meanwhile, the control unit is programmed such that, if a question in a natural language is input in the index database, by the syntax analysis method based on the mobile configuration concept described above, the sentence construction of the query sentence is analyzed; by analyzing the analyzed result of sentence construction analysis, the result is dissected word-by-word according to sentence construction information; by capturing an interrogative form of a question, the dissected detailed question for the sentence analysis dictionary is determined; the tag of the detailed question determined in the sentence analysis dictionary is role-converted into a retrieval tag according to the form of a desired interrogative sentence; a word having the converted retrieval tag is retrieved in the sentence analysis dictionary and the frequency of retrieval is counted; and the retrieved word, sentences containing the retrieval tag, and the contents of a document containing the sentences, are displayed in order of frequency.

Accordingly, the natural language retrieval system implemented by the present invention collects documents to be indexed, then indexes sentences forming each document, and again indexes the grammatical function by component of each sentence according to the output result of the syntax analyzer such that if there is a document containing related information, that document can be accurately found and provided.

For example, in addition to “Nooga Cheolsooreul joahani?” shown in the figures, if a question such as “Cheolsooga noogureul mannadni? (Who did Cheolsoo meet?)” or “Cheolsooga mannan sarameun? (Who did Cheolsoo meet?)” is input, the focus of the question is the object of “manada (to meet)”. Accordingly, by searching for a question sentence having “Cheolsoo” as the subject and an object for the predicate “manada”, results can be provided.

Accordingly, since the method includes meaning information, in the case of a question sentence, similar expressions are automatically determined such that quick and accurate retrieval is enabled and intelligent retrieval containing even meaning calculations is enabled.

In addition, correlation of the retrieval results can be greatly improved, and beyond simple matching retrieval, accurate and intelligent retrieval that even considers grammatical relations is enabled.

Also, there is a new market for a Korean-foreign language translation machine based on this syntax analysis and natural language retrieval. In addition, a variety of markets for processing intelligent languages can be newly created.

For example, an embodiment of the present invention relating to a Korean language application is described above with reference to the drawings. However, the present invention can be applied to other languages having postpositions or endings of great importance, such as Japanese. The natural language retrieval system using the syntax analyzer can also be applied in all fields in which human language must be understood by a computer, for example, in a question and answer system of an artificial intelligence computer or in a search engine of an Internet portal site such as Yahoo.

Accordingly, the scope of the present invention is not determined by the above description but by the accompanying claims, and variations and modifications may be made to the described embodiments without departing from the scope of the invention as defined by the appended claims and their legal equivalents.

1. A syntax analysis method for analyzing syntax and describing the grammatical function of the syntax, after establishing a morpheme dictionary program for analyzing morphemes of an input sentence, a grammar rule database for storing grammar rules, and a subcategorization database for storing the details of subcategories belonging to heads, such as stems of words and word endings, of each component of a sentence such that the syntactic status of an inflective word ending is admitted based on the marker theory which regards both postpositions and endings as syntactic units, and combination relations between words can be grammatically defined as a whole, the method comprising:
analyzing morphemes wherein if a sentence desired to be analyzed is input, the contents of morphemes are analyzed in units of polymorphemes according to the morpheme dictionary program, and after selecting an analysis case of a morpheme appropriate to the input data among morpheme analysis data by polymorpheme, preprocessing is performed; and
analyzing syntax wherein with the analyzed morphemes, partial structures of a sentence are first established according to grammatical roles stored in the grammar rule database, and then, by using the subcategorization database, the entire structure is established and by calculating the weighted value of each structure, a most appropriate optimum case is determined and output.

2. The method of claim 1, wherein analyzing syntax comprises:
performing preprocessing in which whether or not there is a sentence construction included in a multiple morpheme list is determined by a multiple morpheme list program, and if there is a multiple morpheme sentence construction, the multiple morpheme construction is transformed into a multiple morpheme form, and the meanings of words are determined by a semantic feature program and are included in morphemes;
forming a partial structure by operating and repeating an internal loop, wherein if a morpheme tagged with the semantic feature part of speech is input, the morpheme is treated as an individual morpheme, and by determining according to grammatical roles stored in the grammar rule database whether or not local structure rules are applied to a morpheme selected, a local structure is formed, and by referring to a succeeding object to be processed and determining whether or not a recursive local structure is formed, an internal structure is established, and if there are no other internal structures, a following process is repeatedly performed;
forming an entire structure according to the category and a sentence construction and an expression form based on the subcategorization database and the adjunct type database;
selecting an optimum case by calculating the weight of each structure based on the location or the characteristic of a sentence construction and selecting a most important structure; and
outputting an optimum case with mobile type (tree type) linking lines such that relations among the entire structure, each partial structure, and each morpheme of the determined optimum case are correspondingly connected and indicated by the linking lines.

3. The method of claim 2, wherein the semantic feature program is a program for classifying the meanings of words in predetermined types, the meanings as elements for determining the syntactic characteristic of a morpheme and meaning information, such that the meanings contribute to reducing structural equivalency in a compound sentence structure and the list of adjuncts for each inflective word is determined; the multiple morpheme list program is a program performing classification by type in order to classify word features of postpositions in an identical type or suffixes having postposition functions; the grammar rule database stores information defining grammatical roles on respective primitives; the subcategorization database stores information on details of constituents that can belong to an inflective word, and forms of changeable inflective word endings; and the adjunct type database stores information on general features of postpositions, endings, or suffixes having functions similar to postpositions or endings, which determine the type of a local structure capable of being combined by a core word, as elements determining equivalency of a multiple branch structure.

4. A natural language retrieval method for retrieving documents (sentences) by inputting a natural language question using a syntax analysis method based on a mobile configuration concept, the method comprising:
analyzing a document in which sentence analysis information of a document that is an object of retrieval is stored in a sentence information database by a syntax analysis method based on a mobile configuration concept wherein a subcategorization database, which stores the details of subcategories belonging to heads, such as stems of words and word endings, of each component of a sentence such that the syntactic status of an inflective word ending is admitted and the combination relations between words can be grammatically defined as a whole, is established, and if a sentence desired to be analyzed is input, the contents of morphemes are analyzed and with the analyzed morphemes, partial structures of a sentence are first established according to grammatical roles stored in a grammar rule database, and then, by using the subcategorization database, the entire structure is established;
analyzing question syntax in which in the document information database, if a question in a natural language is input, the syntax of the question is first analyzed according to the syntax analysis method based on the mobile configuration concept, the syntax analysis result is dissected in units of words according to syntax information, the interrogative sentence type of a question is captured, and a dissected, detailed question is determined;
retrieving a document in which the role of the tag of the detailed question determined in a sentence analysis dictionary is converted into a tag for retrieval according to the desired interrogative sentence type, a word having the converted tag for retrieval is retrieved in the sentence analysis dictionary, and a ranking is calculated based on the frequency of retrieval; and
displaying a result including retrieved words, sentences including tags for retrieval, and the contents of a document including the sentences.

5. The method of claim 4, wherein retrieving a document comprises:
performing a general retrieval mode (step) in which by using only syntactically analyzed information, and based on only the result of syntax analysis of a question, a document database already analyzed is searched and matching contents are extracted and provided; and
performing a special retrieval mode (step) in which when a special expression is included in a question, according to the selection of a retriever, retrieval conditions for special retrieval mode are generated, by special retrieval rule information and a noun system database, and based on the conditions, contents semantically dependent on a predetermined component are retrieved and provided,
wherein the general retrieval step is formed of a component matching retrieval method by which data matching direct constituents of a given question are extracted and provided, and a meaning matching retrieval method by which constituents forming a question are included and data including predicates that are core words and semantically similar predicates are extracted and provided, and the special retrieval step uses the special retrieval rule information and a database based on a semantic hierarchical structure of a noun such as a noun system database.
